(19) United States
(12) Patent Application Publication
(10) Pub. No.: US 2006/0199543 A1
(43) Pub. Date: Sep. 7, 2006

(54) Low cost indoor test facility and method for mobile satellite antennas

(75) Inventor: Danny Spirtus, Airport City (IL)

Correspondence Address: SUGHRUE MION, PLLC, 2100 PENNSYLVANIA AVENUE, N.W., SUITE 800, WASHINGTON, DC, 20037, US

(73) Assignee: RAYSAT CYPRUS LTD.

(21) Appl. No.: 11/071,440

(22) Filed: Mar. 4, 2005

(51) Int. Cl. H04B 17/00

(52) U.S. Cl. 455/67.11

(57) ABSTRACT

A test system and method for indoor testing of a mobile antenna terminal having a first antenna with a first aperture of a first size and, preferably, operable in a receive-only mode and/or a transmit and receive mode. The system uses a second antenna having a dual port feed and a reflector, the second antenna having a second aperture of a second size, which is two or more times the first size, and being operative to form a plane wave. The first antenna is mounted to a test platform that is positioned within the second aperture and is operative for rotating and tilting movement of the antenna to simulate movement on a vehicle. The test system uses a source of RF test signals and communications test equipment coupled to at least the first antenna, as well as a processor for determining a performance of the mobile antenna terminal.

### FIELD OF INVENTION

The present invention refers to a method and apparatus for indoor rapid and cost-effective tests of mobile tracking antennas for satellite (or terrestrial) communications.

In particular, the invention concerns a low cost antenna test range based on a standard off-the-shelf reflector antenna, a mobile environment simulation device, and a source of an actual modulated satellite signal or a simulated satellite (or another type) signal to the test antenna. The tracking and recognition capabilities of a mobile antenna terminal may be tested in a compact indoor environment. The disclosed method and apparatus permits a rapid assessment and diagnosis, including final production tests, of receive only or two-way (receive and transmit) mobile antenna terminals for broadband satellite (or terrestrial) communications. The invention permits a simple test set-up requiring minimal training of personnel.

### BACKGROUND OF THE INVENTION

Designs and techniques for an indoor antenna test facility, using an antenna reflector test range that simulates far field range (sometimes called “compact range”), are disclosed in many technical reports, textbooks and articles [for example “Compact Antenna Test Range Without Reflector Edge Treatment and RF Anechoic Chamber by Chang D., Liao C. and Wu C., IEEE Antennas & Propagation Magazine, Vol. 46, No4, August 2004 pp 27-37]. The main principle of operation for such facilities is based on the use of a shaped reflector to produce a plane wave in the area where the antenna under test is situated in order to correctly measure the antenna's far field performance. Such compact range facilities typically require a very precise reflector surface for the accurate measurement of the antenna parameters, resulting in high cost. Furthermore, highly skilled personal are typically needed to perform the tests, which are time consuming thereby making impractical such ranges for a mass production testing environment.

Thus, one objective of the invention is to provide a system, method and apparatus set up for simple, rapid, low cost indoor functional tests of mobile satellite (or terrestrial) antenna terminals.

### SUMMARY OF THE INVENTION

The invention concerns a test system and method for indoor testing of a mobile antenna terminal having a first antenna with a first aperture of a first size and, preferably, operable in a receive-only mode and/or a transmit and receive mode. The system uses a second antenna having a dual port feed and a reflector, the second antenna having a second aperture of a second size, which is two or more times the first size, and being operative to form a plane wave. The first antenna is mounted to a test platform that is positioned within the second aperture and is operative for a programmed rotating and tilting movement of the antenna to simulate movement on a vehicle. The test system uses a source of RF test signals and communications test equipment coupled to at least the first antenna, as well as a processor for determining a performance of the mobile antenna terminal.

The invention is described in accordance with multiple exemplary embodiments, but is not limited to the details or even common features thereof. The exemplary embodiments are provided in order to provide an indication of the broad range of applications for the invention.

According to one exemplary embodiment of the invention, a simple off the shelf reflector antenna is used to generate a plane wave in the area where the antenna terminal under test is situated. The diameter of the reflector is chosen to be larger than the antenna under test in order to ensure relatively uniform amplitude and phase distribution of the electromagnetic field over the test area. A reflector with an off set geometry is preferable in order to minimize shadowing and to ensure better planarity of the wave in the near field plane wave region. An off-the-shelf reflector may be used with the present invention, since the objective is to conduct final system tests (for example acquisition and tracking antenna capabilities) or to determine antenna parameters required by a defined specific acceptance test procedure.

The plane wave is properly modulated to present the test terminal with an actual or realistically simulated satellite (or another type) signal. In a case when a satellite communication antenna is under test, this is accomplished by using a standard satellite reflector antenna, which is mounted outside and has direct line of site view to a selected geostationary satellite having one or more transponders. A low noise block (LNB), down converts the signals of the chosen satellite transponder. This signal is then fed to an upconverter and thereafter to the antenna reflector test range feed. The modulated plane wave falling over the antenna under test is adjusted to have the intensity (field strength) and has modulation identical to the case when the antenna terminal under test is situated in the open space, directed toward the selected satellite and tuned to the selected transponder.

In another exemplary embodiment, a digital video broadcast (DVB) signal could be provided using the DVB streamer to reproduce initially recorded baseband DVB streams and a DVB modulator. This way of forming the test signal may be used when a clear line of sight to an actual satellite is not possible or in case when other types of test signals are required.

Given the presence of the properly modulated plane wave from the antenna reflector test range, the rotation platform upon which the antenna terminal under test is mounted, can be put in operation and the antenna tracking and recognition capabilities under simulated vehicle motion scenarios can be tested, for example, for different speeds of rotation at different elevation angles. The system parameters such as signal to noise ratio, bit error rate (BER), maximal tracking speed, and initial time for recognition and satellite locking can be measured and compared with desired specifications. Additionally a very simple pass/fail final functional test can be applied by direct comparison with a proper “reference” antenna, verifying at the end of the production process the antenna terminal's capability to recognize and track the satellite.

In another exemplary embodiment of the invention, the system can be used for two-way mobile terminals tests. In such embodiment, it is preferable to use a feed comprising an orthomode device supporting two orthogonal linear polarizations. One of the orthomode inputs could be used in transmit mode to provide a plane wave modulated by the proper DVB (or another type) signal, supplied by one of the embodiments described above, in order to test acquisition and tracking capabilities of the antenna under test in receiving mode. The second orthomode input, operating in receive mode, may be used to test the effective isotropically radiated power (EIRP) transmitted by the antenna under test while operating in transmit mode.

Another exemplary embodiment of the invention provides a capability to test mobile antennas, which support data communication and at the same time reception of TV programs from a DBS satellite located at the same orbital position with the FSS satellite providing data communication service.

### BRIEF DESCRIPTION OF THE DRAWINGS

FIG. 1 illustrates the geometry of a low cost antenna reflector test range according to an exemplary embodiment of the invention.

FIG. 2 illustrates a block diagram of the test set up for receive only antenna tests in accordance with another exemplary embodiment of the invention.

FIG. 3 Illustrates flow chart of the disclosed method in accordance with an embodiment of the invention.

FIG. 4 illustrates a block diagram of the test set up for two-way antenna tests in accordance with a further exemplary embodiment of the invention FIG. 5 illustrates block diagram of the test set up for the test of a mobile antenna, which is able to support data communication service and at the same time reception of TV programs.

### DESCRIPTION OF THE PREFERRED EMBODIMENTS

The claims alone represent the metes and bounds of the invention. The discussed implementations, embodiments and advantages are merely exemplary and are not to be construed as limiting the present invention. The description of the present invention is intended to be illustrative, and is not intended to limit the scope of the claims. Many alternatives, modifications and variations will be apparent to those skilled in the art.

The present invention may be exemplified by several applications of the methods and system embodying low cost facilities for indoor testing of mobile antennas for broadband satellite (or terrestrial) communications using an antenna reflector test range with plane wave supplied by a standard off-the-shelf reflector antenna and an actual or simulated satellite (or other type) signal provided by either an auxiliary antenna or a DVB streamer.

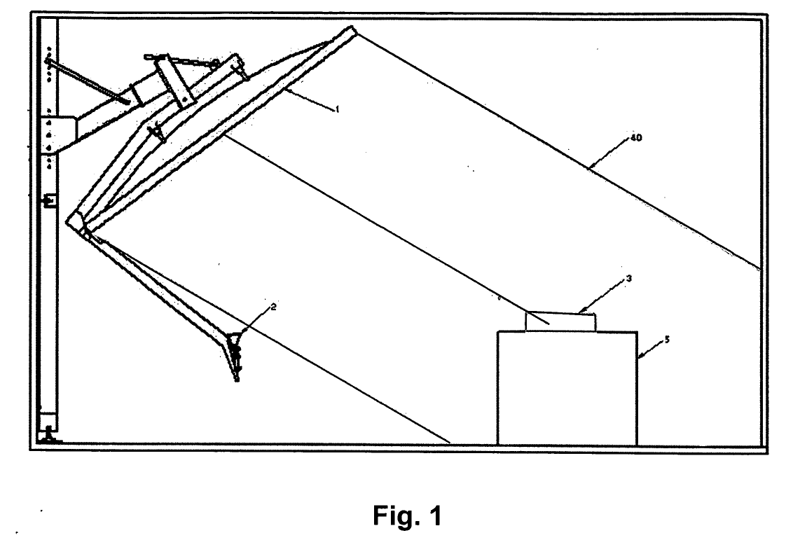

One exemplary embodiment of the low cost antenna reflector test range configuration is illustrated in FIG. 1. The, a conventional antenna 1, which may be an off the shelf reflector antenna 1, preferably has a preferred size of the antenna aperture needed to form the plane wave 40 selected to be at least 2 times larger that the aperture of the antenna under test 3. In the case of a specific application the reflector diameter is selected to be 2.4 meters for testing of an antenna with an aperture size of around 0.8 meters. The reflector antenna 1 is selected to have offset configuration in order to avoid shadowing and to achieve more uniform phase and amplitude distribution around the antenna under test 3. The antenna under test is mounted on a rotating platform (pedestal) 5, which can be programmed to automatically move the antenna under test 3 with specified angular range and speed around the defined rotation axes. In one specific embodiment the angle for rotation in elevation could be between 20 and 70 degrees while keeping full 360 degrees rotation in azimuth.

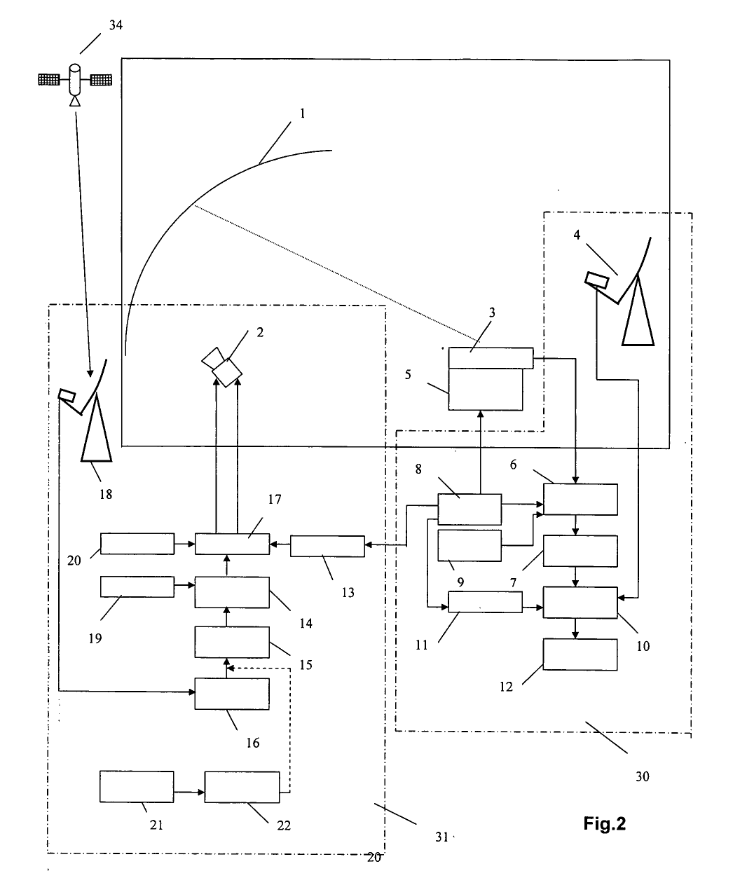

A further understanding of the basic features of the invention can be obtained from the exemplary test system applicable to testing of receive only antennas, as illustrated in FIG. 2. The illustrated test system comprises two sets of equipment: a transmit set 31 and a receive set 30.

The transmit set 31 includes: outdoor standard receive antenna 18, Low noise block (LNB) 16, IF/RF system up converter 14, attenuator 15, RF switch 17, interface circuit 13, power supply units 19 and 20, and reflector range feed horn 2. In another exemplary embodiment, a DVB streamer 21 and QPSK modulator (or another proper type of modulator) 22 is used.

The receive test set 30 includes: indoor unit 6; reference antenna 4; attenuator 7; RF switch 10; test receiver 12; interface circuit 11 and power supply unit 9. The computer system 8 is used to control both transmit and receive sets of equipment.

The test system 3 is connected to the indoor unit block 6, which provides power supply to the antenna terminal under test 3, enables satellite recognition function and ensures proper interface with the test receiver 12 and the controlling computer 8. Power supply unit 9 provides DC bias to the indoor unit 6 and antenna terminal under test 3. An attenuator 7 is connected between the indoor unit 6 and the test receiver 12 in order to adjust the proper signal level and to ensure good isolation and matching. An RF switch 10, controlled by the computer system 8 through the interface circuit 11, is connected in order to switch the test receiver 12 between the antenna under test and a reference antenna 4 (with well defined performance) for comparison.

An RF test signal is formed in the transmit set 31. In one embodiment the primary source of the test signal is a standard off the shelf reflector antenna 18, connected to the Low Noise Block (LNB) 16, which down converts the DVB RF signal, coming from the selected satellite transponder and then up converted again by the IF/RF upconverter 14. The antenna 18 is mounted outside, in the open space, having clear line of sight with the geostationary satellite 34 that is selected for communication.

In another embodiment the test signal could be provided by a standard DVB streamer 21 and a QPSK modulator 22 (or another suitable modulator). The DVB streamer 21 comprises DVB stream recorder and DVB player sets. The DVB stream recorder may be used to record suitable DVB data streams that are needed for appropriately testing the acquisition and tracking capabilities of the mobile system under test 3. The recorded data (DVB streams) are then reproduced by the DVB player and then provided to the QPSK modulator 22 (or another suitable modulator) in order to form a baseband test signal at the output of the modulator 22. The baseband test signal is transferred through the attenuator 15 in order to adjust properly the level of the baseband signal and then is upconverted using the IF/RF upconverter 14, forming in that way an RF test signal at the output of the IF/RF upconverter 14. The RF switch 17 is used to deliver the RF test signal to any one of the two inputs of the feed 2 situated at the focal point of the antenna test range reflector 1. Each one the feed 2 inputs is dedicated to one of two polarizations. The polarizations could be Left Hand Circular (LHCP) and Right Hand Circular (RHCP) Polarizations or Horizontal (HP) and Vertical (VP) Linear Polarizations depending on the specifications of the system under test. The feed 2 comprises feed horn, orthogonal mode transducer (orthomode) and polarizing devices in order to form the RF test signal with appropriate polarization simultaneously, illuminating properly the test range reflector 1. Power supply units 9, 19 and 20 provide the necessary supply voltages to the indoor unit (IDU) 6, IF/RF upconverter 14 and RF switch 17 respectively. The dedicated computer system 8 provides control to the IDU 6, and switches 10 and 17 through the interface circuits 11 and 13.

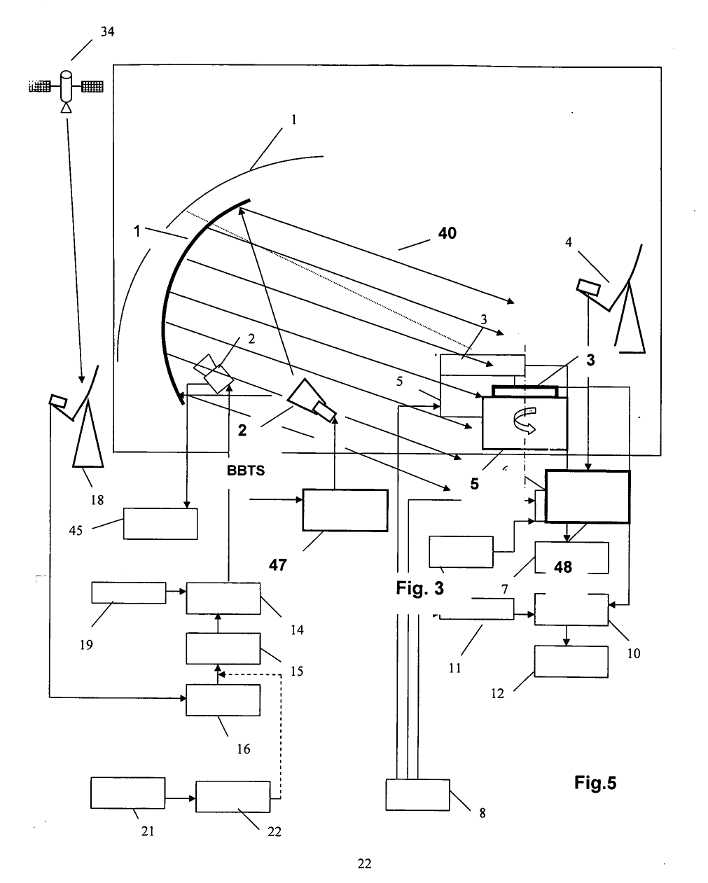

The foregoing arrangement may be used to implement a method of indoor testing of a mobile antenna terminal having an antenna with an aperture of a desired size. According to a first step (S-1) of the method, as illustrated in FIG. 3, a second antenna, which has at least a feed and a reflector, is provided for forming a plane wave, and is oriented to allow the wave to encompass the mobile antenna terminal. As previously noted, the second antenna has a second aperture of a size, which is two or more times the of the aperture of the antenna on the mobile antenna terminal. In a second step (S-2), an RF test signal, properly modulated by a base band test signal (BBTS) and formed by a transmit set of equipment 47, which simulates signals with respect to a repeater in open space, is provided to the feed of the second antenna for radiation onto said second antenna reflector. The RF test signal is reflected onto the antenna of the terminal under test. In a third step (S-3), the antenna in the mobile terminal is moved within the second aperture by automatically changing rotation and tilt, such that movement of the first antenna simulates movement in the field of the mobile antenna terminal with respect to a remote repeater, such as a satellite transponder. In a fourth step (S-4), the signal received by the first antenna is analyzed by a receive equipment test set 48 in order to determine the performance of the mobile antenna terminal.

While the above method is described for a receive function of the terminal, the method can be expanded to cover testing of both transmit and receive functions. In such case, a predetermined transmit signal would be provided to the terminal for radiation by the antenna to the reflector of the second antenna, or reception by the feed.

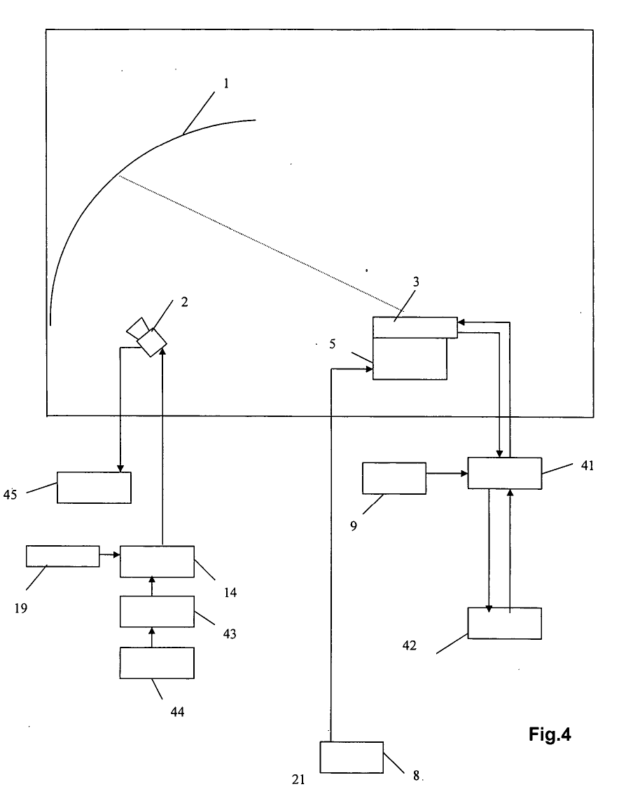

In another exemplary embodiment of the invention as illustrated in FIG. 4, the foregoing method may be applied to the final test of a two-way (receive/transmit) mobile antenna for data communication (for example Internet). In case of this specific embodiment, it is convenient to use a feed 2 comprising horn and orthomode device, which has two independent ports dedicated to two orthogonal linear polarization (for example horizontal H and vertical V). To one of the ports a proper RF signal modulated by a proper base band test signal is provided in order to test the acquisition and tracking capabilities of the antenna under test 3 in receive mode. The RF signal is formed by test set up comprising computer 44, modem 43, IF/RF upconverter 14 and power supply 19. The test RF signal is then radiated by the feed 2 and reflected by the test range reflector 1 in order to form a proper plane wave over the place where the antenna under test 3 is situated. The RF signal, reflected by the reflector 1 is then received by the antenna under test 3 and is transferred through the indoor unit 41, which comprises a modem device, and the demodulated test signal is provided to the computer or to another proper equipment capable to measure the communication speed and the link system parameters 42. A power supply unit 9 provides DC bias for the indoor unit 41 and antenna under test 3.

At the same time, the signal (which has linear polarization orthogonal to the polarization of the test RF signal) transmitted by the antenna under test 3, working in transmit mode, is reflected by the test range reflector 1 and received by the feed 2. The transmit CW or modulated signal, reflected by the test range reflector 1, appears at the second port of the feed 2 connected to the power meted or another suitable equipment 45 in order to measure the power level of the signal transmitted by the antenna under test 3 and then to compare this measured level to the one defined by the specifications.

A complete test of a mobile two-way antenna terminal could be performed following the test procedure described above. The capabilities of the antenna under test 3 to acquire and track the signals coming from a communication satellite, while rotating with required speed in azimuth and elevation (simulating vehicle movement), could be tested first, using the plane wave formed by the compact test range reflector 1, modulated by the proper RF signal and then when the test signal is locked properly and the transmission mode is allowed by the Central Processing Unit (CPU) of the antenna under test 3, to enable the transmit mode and to test the level of the transmit power.

In another exemplary embodiment illustrated in FIG. 4, the method may be applied to final tests of mobile antennas, which could provide a capability of two-way data communications through selected FSS satellite (for example Internet) and at the same time reception of TV programs from a DBS satellite located at the same orbital position. In case of this specific embodiment, it is convenient to use a feed 2, comprising a horn and an orthomode device, which has two independent ports dedicated to two orthogonal linear polarization (for example horizontal H and vertical V). To one of them a proper DVB signal is provided in order to test the acquisition and tracking capabilities of the antenna under test 3 in a receive mode. The DVB signal is formed by one of the two methods, described previously, using signal received by a standard reflector antenna 18, mounted outside on a place having clear line of sight with a geostationary satellite 34, selected for communication or by a standard DVB streamer 21 and a QPSK modulator 22 (or another suitable modulator). At the same time, the signal (which has linear polarization orthogonal to the polarization of the test DVB signal) transmitted by the antenna under test 3, working in transmit mode, is reflected by the compact range reflector 1 and received by the feed 2. The transmit signal, reflected by the test range reflector 1, appears at the second port of the feed 2 connected to the power meter or another suitable equipment 45 in order to measure the power level of the signal transmitted by the antenna under test 3 and then to compare this measured level to one defined by the specifications.

Following the test procedure described above, a complete test of such type of mobile two-way antennas could be performed. The capabilities of the antenna under test 3 to acquire and track the signals coming from a communication satellite, while rotating with required speed in azimuth and elevation (simulating in that way vehicle movement), could be tested first, using the plane wave formed by the compact test range reflector 1, modulated by the proper DVB signal and then when the test signal is locked properly and the transmission mode is allowed by the central processing unit (CPU) of the antenna under test 3, to enable the transmit mode and to test the level of transmit power.

The foregoing embodiments and advantages are merely exemplary and are not to be construed as limiting the present invention. The description of the present invention is intended to be illustrative, and is not intended to limit the scope of the claims. Many alternatives, modifications, and variations will be apparent to those skilled in the art.

1. A test system for indoor testing of a mobile antenna terminal having a first antenna with a first aperture of a first size, comprising:
a second antenna comprising at least one feed and a reflector, said second antenna having a second aperture of a second size, which is two or more times said first size, and being operative to form a plane wave;
a source of an RF test signal, which simulates signals with respect to a repeater in open space, for coupling to said at least one feed;
a test platform that is positioned within said second aperture and adapted for mounting said first antenna to receive said plane wave, said test platform being operative for rotating and tilting movement of said first antenna;
communications test equipment coupled to said first antenna; and
a processor coupled to said communications test equipment for determining a performance of said mobile antenna terminal.

2. The test system of claim 1, further comprising means for automatically testing antenna acquisition and tracking capabilities of said mobile antenna terminal.

3. The test system of claim 1, wherein the first antenna is a two-way transmit-receive antenna, said system further comprising means for measuring and comparing a transmit power level of the transmit-receive antenna with predetermined performance criteria.

4. The test system of claim 1 wherein said test platform is programmably controllable for movement that simulates movement of the mobile antenna terminal with respect to a remote repeater.

5. The test system of claim 4, wherein said test platform and said RF test signal source are controlled automatically.

6. The test system of claim 1, wherein said reflector of said second antenna has an off set configuration.

7. The test system of claim 1, wherein the RF test signal is formed from a base band signal, containing a DVB stream data.

8. The test system of claim 7, further comprising a third antenna, comprising a reflector antenna mounted to have a clear line of site to a repeater of a satellite in geostationary orbit, wherein the base band signal is formed using signals received by said third antenna.

9. The test system of claim 7, wherein the base band signal is formed using a means for reproducing pre-recorded DVB data and a QPSK, BPSK, 8PSK or another proper modulator.

10. The test system of claim 1, wherein said at least one feed comprises two inputs, and the system further comprises an RF switching device, said RF switching device being operative to switch the RF test signal between said two inputs in order to change polarization of said RF test signal.

11. The test system of claim 10, wherein a polarization of the RF test signal comprises one of Left Hand Circular polarization (LHCP) and Right Hand Circular (RHCP) polarization.

12. The test system of claim 10, wherein a polarization of the RF test signal comprises one of a Vertical Linear polarization (VLP), Horizontal Linear polarization (HLP) and tilted linear polarizations.

13. The test system of claim 1 wherein said at least one feed comprises a radiator, polarizer and orthomode devices operative to form circular polarized signals for illuminating the second antenna reflector.

14. The test system of claim 1, wherein said at least one feed comprises a radiator and orthomode device operative to form linear polarized signals for illuminating the second antenna reflector.

15. The test system of claim 4, further comprising a reference antenna and a test receiver, said reference antenna and said first antenna being coupled switchably to said test receiver.

16. The test system of claim 15 further comprising an RF switch operating under control of a computer system for switching an output of each said antenna to the test receiver.

17. The test system of claim 4, wherein the low cost reflector antenna range comprises a reflector antenna and a dual port feed, supporting two orthogonal linear polarizations and operative to test a two-way mobile antenna terminal in receive and transmit modes.

18. The test system of claim 1, further comprising a source of modulation to produce a modulated RF signal, wherein said feed is a dual port feed, said modulated RF signal being provided to one port of the dual port feed to test the mobile antenna terminal in a receive mode, and a transmit signal from the first antenna, as reflected by the reflector, being provided to the second port of the feed to test the mobile antenna in a transmit mode.

19. A method of indoor testing of a mobile antenna terminal having a first antenna with a first aperture of a first size, comprising:
providing a second antenna, comprising a feed and a reflector, with a second aperture of a second size, which is two or more times said first size, and being operative to form a plane wave;
providing a source of an RF test signal, which simulates signals with respect to a repeater in open space, to said feed for radiation onto said second antenna reflector;
moving said first antenna within said second aperture by changing rotation and tilt, such that movement of said first antenna simulates movement in the field of said mobile antenna terminal with respect to a remote repeater; and
analyzing a signal received by said first antenna for determining a performance of said mobile antenna terminal.

20. The method for indoor testing of claim 19, wherein said second antenna feed is operative to transmit and receive RF signals, further comprising, providing a modulated RF signal to test the mobile antenna terminal in a receive mode, and
providing a transmit signal from the first antenna to the reflector for reception by the feed, to test the mobile antenna in a transmit mode.
